(19) United States
(12) Patent Application Publication
(10) Pub. No.: US 2016/0278605 A1
(43) Pub. Date: Sep. 29, 2016

(54) DISHWASHER APPLIANCE AND A METHOD FOR FORMING A UNITARY FILTER FOR A DISHWASHER APPLIANCE

(71) Applicant: GENERAL ELECTRIC COMPANY, Schenectady, NY (US)

(72) Inventors: Gregory Owen Miller, Louisville, KY (US); John Edward Dries, Louisville, KY (US)

(21) Appl. No.: 14/664,973

(22) Filed: Mar. 23, 2015

(51) Int. Cl. A47L 15/42; C02F 1/00; B01D 35/26; B08B 3/14; B01D 35/02; B01D 33/00

(52) U.S. Cl. CPC A47L 15/4206; B01D 35/02; B01D 33/0093; B01D 35/26; B08B 3/14; C02F 1/00; C02F 2103/002

(57) ABSTRACT

A dishwasher appliance includes a sump assembly with a unitary filter for filtering wash fluid supplied to a wash chamber of the dishwasher appliance. The unitary filter defines a central axis. The unitary filter also has a filter medium with an inner surface that defines an interior chamber of the filter medium. A cross-sectional area of the interior chamber in a plane that is perpendicular to the central axis changes along a length of the central axis. A related method for forming a unitary filter for a dishwasher appliance is also provided.

### FIELD OF THE INVENTION

The present subject matter relates generally to dishwasher appliances and filters for dishwasher appliances.

### BACKGROUND OF THE INVENTION

Dishwasher appliances generally include a tub that defines a wash chamber. A user of the dishwasher appliance can load articles into the wash chamber and activate the dishwasher appliance to clean the articles. During operation, certain dishwasher appliances spray wash fluid onto the articles within the wash chamber in order to remove food particles and other debris from the articles. A pump generally circulates wash fluid within the wash chamber across the articles throughout a wash cycle of the dishwasher appliance in order to clean the articles. Thus, a significant volume of food particles and other debris can accumulate within the wash fluid during wash cycles.

To avoid redepositing the food particles and other debris on the article being washed, certain dishwasher appliances includes filters that remove the food particles and other debris from the wash fluid prior to spraying the wash fluid onto articles in the wash chamber. However, filters can suffer certain drawbacks. For example, course filters can permit relatively small particles to pass through the course filters and be resprayed onto the articles in the wash chamber. As another example, fine filters can quickly clog with debris during wash cycles. Fine filters can also be expensive to manufacture. For example, fine filters are generally constructed of metallic fibers that require significant tooling to manufacture relative to injection molded plastic filters.

Accordingly, a filter for improving performance of a dishwasher appliance would be useful. In particular, a fine filter for a dishwasher appliance that is constructed of a non-metallic material and that is not formed by injection molding would be useful.

### BRIEF DESCRIPTION OF THE INVENTION

The present subject matter provides a dishwasher appliance. The dishwasher appliance includes a sump assembly with a unitary filter for filtering wash fluid supplied to a wash chamber of the dishwasher appliance. The unitary filter defines a central axis. The unitary filter also has a filter medium with an inner surface that defines an interior chamber of the filter medium. A cross-sectional area of the interior chamber in a plane that is perpendicular to the central axis changes along a length of the central axis. A related method for forming a unitary filter for a dishwasher appliance is also provided. Additional aspects and advantages of the invention will be set forth in part in the following description, or may be apparent from the description, or may be learned through practice of the invention.

In a first exemplary embodiment, a dishwasher appliance is provided. The dishwasher appliance includes a tub that defines a wash chamber. A sump assembly is positioned at a bottom portion of the tub. The sump assembly includes a pump and a unitary filter. The pump is configured for urging wash fluid from the wash chamber of the tub through the unitary filter. The unitary filter defines a central axis. The unitary filter has a filter medium with an inner surface that defines an interior chamber of the filter medium. A cross-sectional area of the interior chamber in a plane that is perpendicular to the central axis changes along a length of the central axis.

In a second exemplary embodiment, a method for forming a unitary filter for a dishwasher appliance is provided. The method includes establishing three-dimensional information of the unitary filter and converting the three-dimensional information of the unitary filter from the step of establishing into a plurality of slices. Each slice of the plurality of slices defines a respective cross-sectional layer of the unitary filter. The method also includes successively forming each cross-sectional layer of the unitary filter with an additive process. After the step of successively forming, the unitary filter defines a central axis and has a filter medium with an inner surface that defines an interior chamber of the filter medium. A cross-sectional area of the interior chamber in a plane that is perpendicular to the central axis also changes along a length of the central axis after the step of successively forming.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a front elevation view of a dishwasher appliance according to an exemplary embodiment of the present subject matter.

FIG. 2 provides a side, section view of the exemplary dishwasher appliance of FIG. 1.

FIG. 3 provides a perspective view of a unitary filter according to an exemplary embodiment of the present subject matter.

FIG. 4 provides a side, elevation view of the exemplary unitary filter of FIG. 3.

FIG. 5 provides a top, plan view of the exemplary unitary filter of FIG. 3.

FIG. 6 provides a section view of the exemplary unitary filter of FIG. 3.

FIG. 7 illustrates a method for forming a unitary filter according to an exemplary embodiment of the present subject matter.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

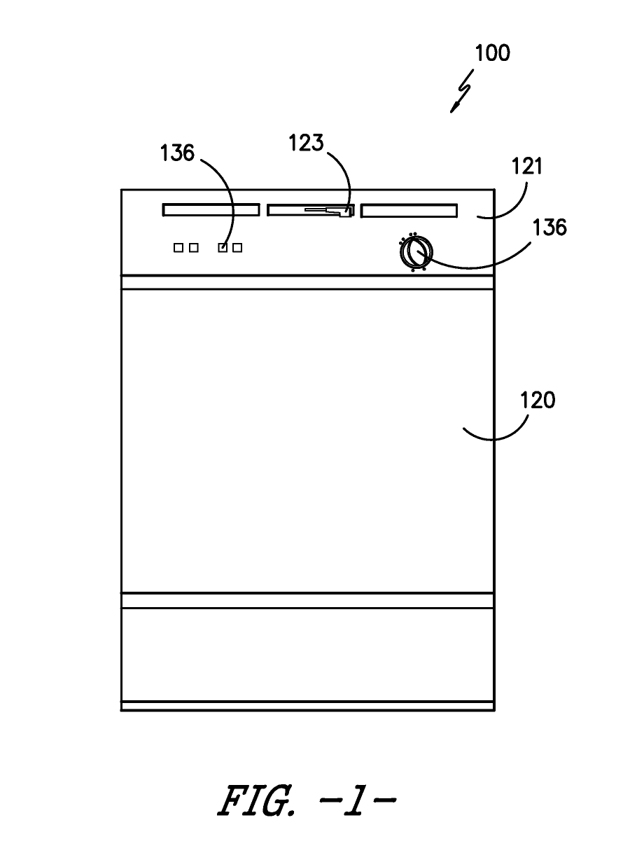

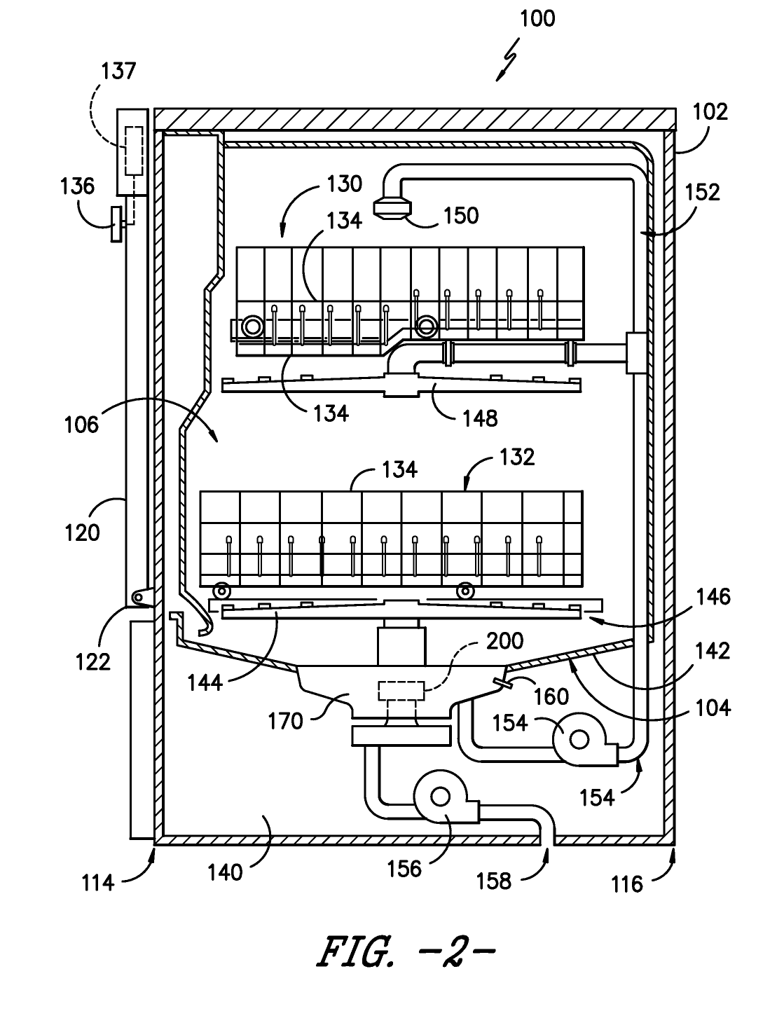

FIGS. 1 and 2 depict a dishwasher appliance 100 according to an exemplary embodiment of the present subject matter. As shown in FIG. 1, dishwasher appliance 100 includes a cabinet 102. Cabinet 102 has a tub 104 therein that defines a wash chamber or compartment 106. The tub 104 also defines a front opening (not shown). Dishwasher appliance 100 includes a door 120 hinged at a bottom 122 of door 120 for movement between a normally closed, vertical position (shown in FIGS. 1 and 2), wherein wash compartment 106 is sealed shut for washing operation, and a horizontal, open position for loading and unloading of articles from dishwasher appliance 100. Latch 123 is used to lock and unlock door 120 for access to wash compartment 106. Tub 104 also includes a sump assembly 170 positioned adjacent a bottom portion 112 of tub 104 and configured for receipt of a liquid wash fluid (e.g., water, detergent, wash fluid, and/or any other suitable fluid) during operation of dishwasher appliance 100.

A spout 160 is positioned adjacent sump assembly 170 of dishwasher appliance 100. Spout 160 is configured for directing liquid into sump assembly 170. Spout 160 may receive liquid from a water supply, such as a municipal water supply or a well. In alternative embodiments, spout 160 may be positioned at any suitable location within dishwasher appliance 100, e.g, such that spout 160 directs liquid into tub 104. Spout 160 may include a valve (not shown) such that liquid may be selectively directed into tub 104. Thus, for example, during the cycles described below, spout 160 may selectively direct water and/or wash fluid into sump assembly 170 as required by the current cycle of dishwasher appliance 100.

Rack assemblies 130 and 132 are slidably mounted within wash compartment 106. Each of the rack assemblies 130 and 132 is fabricated into lattice structures including a plurality of elongated members 134. Each rack of the rack assemblies 130 and 132 is adapted for movement between an extended loading position (not shown) in which the rack is substantially positioned outside the wash compartment 106, and a retracted position (shown in FIGS. 1 and 2) in which the rack is located inside the wash compartment 106. A silverware basket (not shown) may be removably attached to rack assembly 132 for placement of silverware, utensils, and the like, that are otherwise too small to be accommodated by the racks 130 and 132.

Dishwasher appliance 100 further includes a lower spray assembly 144 that is rotatably mounted within a lower region 146 of the wash compartment 106 and above sump assembly 170 so as to rotate in relatively close proximity to rack assembly 132. A mid-level spray assembly 148 is located in an upper region of the wash compartment 106 and may be located in close proximity to upper rack 130. Additionally, an upper spray assembly 150 may be located above the upper rack 130.

The lower and mid-level spray assemblies 144 and 148 and the upper spray assembly 150 are fed by a fluid circulation assembly 152 for circulating water and dishwasher fluid in the tub 104. Fluid circulation assembly 152 may include a wash or recirculation pump 154 and a cross-flow/drain pump 156 located in a machinery compartment 140 located below sump assembly 170 of the tub 104, as generally recognized in the art. Cross-flow/drain pump 156 is configured for urging wash fluid within sump assembly 170 out of tub 104 and dishwasher appliance 100 to a drain 158. Recirculation pump 154 is configured for supplying a flow of wash fluid from sump assembly 170 to spray assemblies 144, 148 and 150. A filter 200 within sump assembly 170 may assist with removing food particles or other debris from wash fluid supplied to fluid circulation assembly 152.

Each spray assembly 144 and 148 includes an arrangement of discharge ports or orifices for directing wash fluid onto dishes or other articles located in rack assemblies 130 and 132. The arrangement of the discharge ports in spray assemblies 144 and 148 provides a rotational force by virtue of wash fluid flowing through the discharge ports. The resultant rotation of the lower spray assembly 144 provides coverage of dishes and other dishwasher contents with a spray of wash fluid.

Dishwasher appliance 100 is further equipped with a controller 137 to regulate operation of the dishwasher appliance 100. Controller 137 may include a memory and microprocessor, such as a general or special purpose microprocessor operable to execute programming instructions or micro-control code associated with a cleaning cycle. The memory may represent random access memory such as DRAM, or read only memory such as ROM or FLASH. In one embodiment, the processor executes programming instructions stored in memory. The memory may be a separate component from the processor or may be included onboard within the processor. Alternatively, controller 137 may be constructed without using a microprocessor, e.g., using a combination of discrete analog and/or digital logic circuitry (such as switches, amplifiers, integrators, comparators, flip-flops, AND gates, and the like) to perform control functionality instead of relying upon software.

Controller 137 may be positioned in a variety of locations throughout dishwasher appliance 100. In the illustrated embodiment, controller 137 may be located within a control panel area 121 of door 120 as shown. In such an embodiment, input/output (“I/O”) signals may be routed between the control system and various operational components of dishwasher appliance 100 along wiring harnesses that may be routed through the bottom 122 of door 120. Typically, controller 137 includes a user interface panel 136 through which a user may select various operational features and modes and monitor progress of the dishwasher appliance 100. In one embodiment, user interface 136 may represent a general purpose I/O (“GPIO”) device or functional block. In one embodiment, user interface 136 may include input components, such as one or more of a variety of electrical, mechanical or electro-mechanical input devices including rotary dials, push buttons, and touch pads. User interface 136 may include a display component, such as a digital or analog display device designed to provide operational feedback to a user. User interface 136 may be in communication with controller 137 via one or more signal lines or shared communication busses.

It should be appreciated that the subject matter disclosed herein is not limited to any particular style, model or configuration of dishwasher appliance, and that the embodiment depicted in FIGS. 1 and 2 is for illustrative purposes only. For example, instead of the racks 130 and 132 depicted in FIG. 1, dishwasher appliance 100 may be of a known configuration that utilizes drawers that pull out from the cabinet and are accessible from the top for loading and unloading of articles.

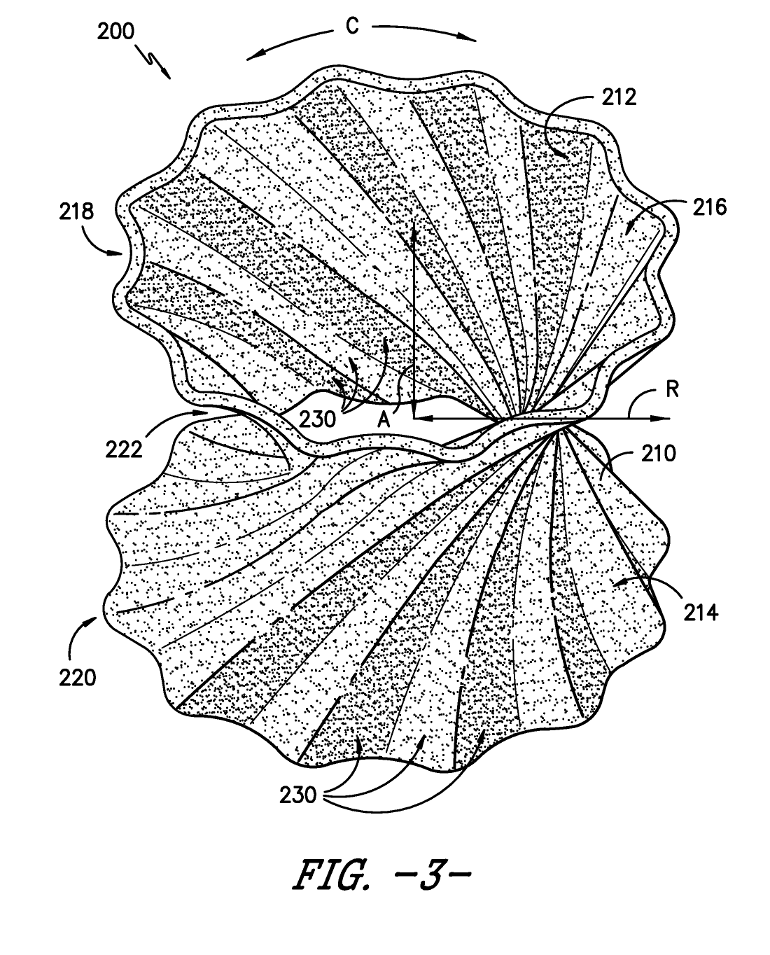

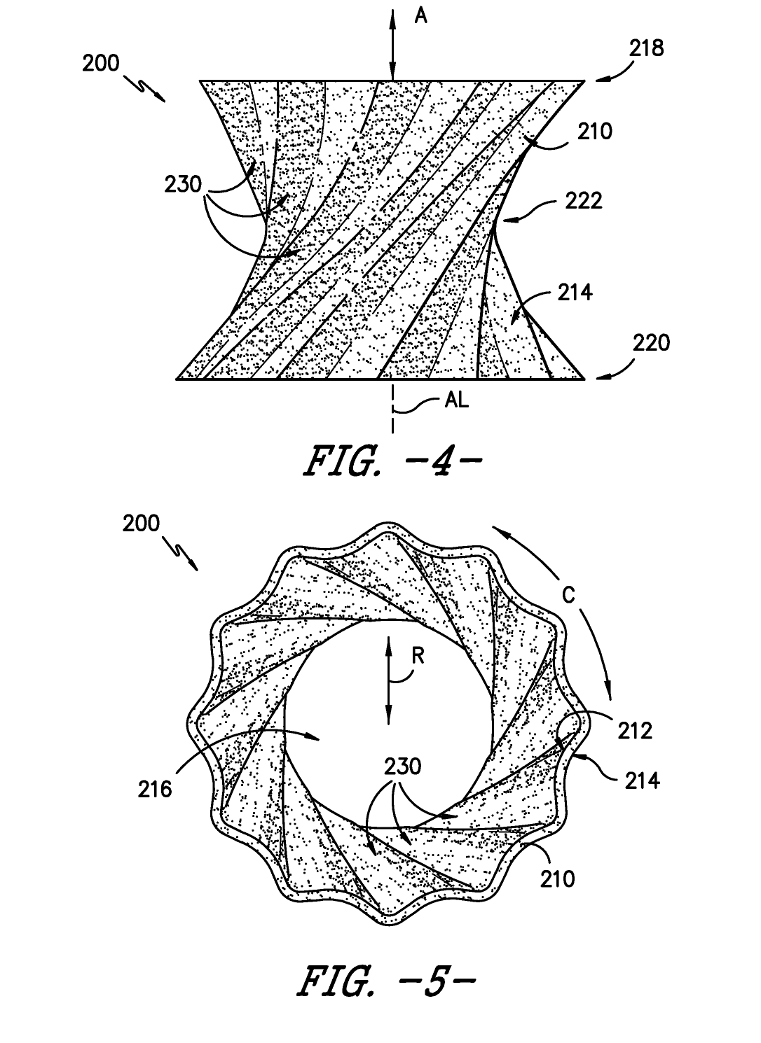

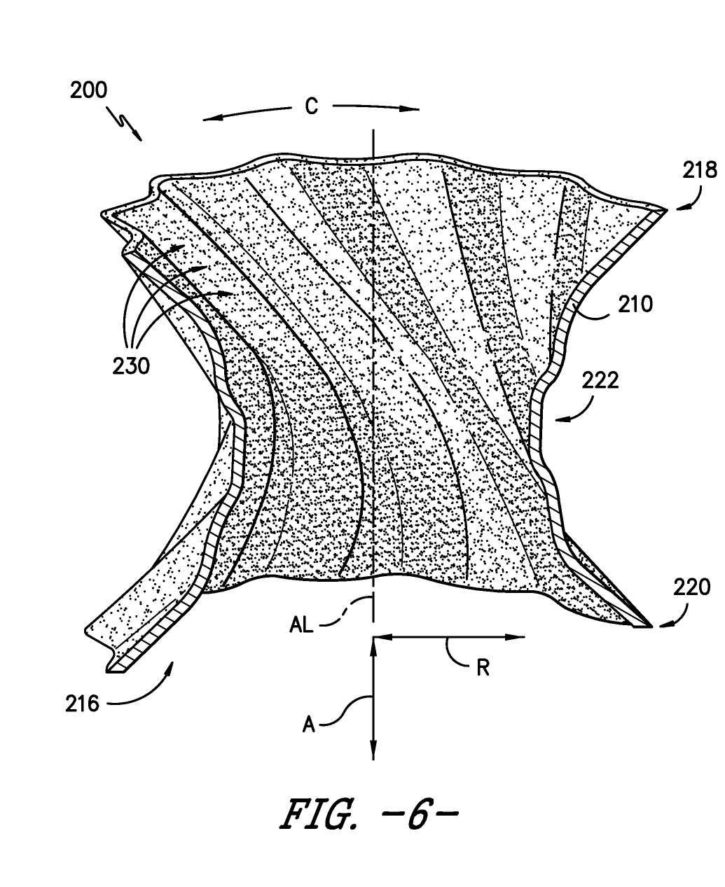

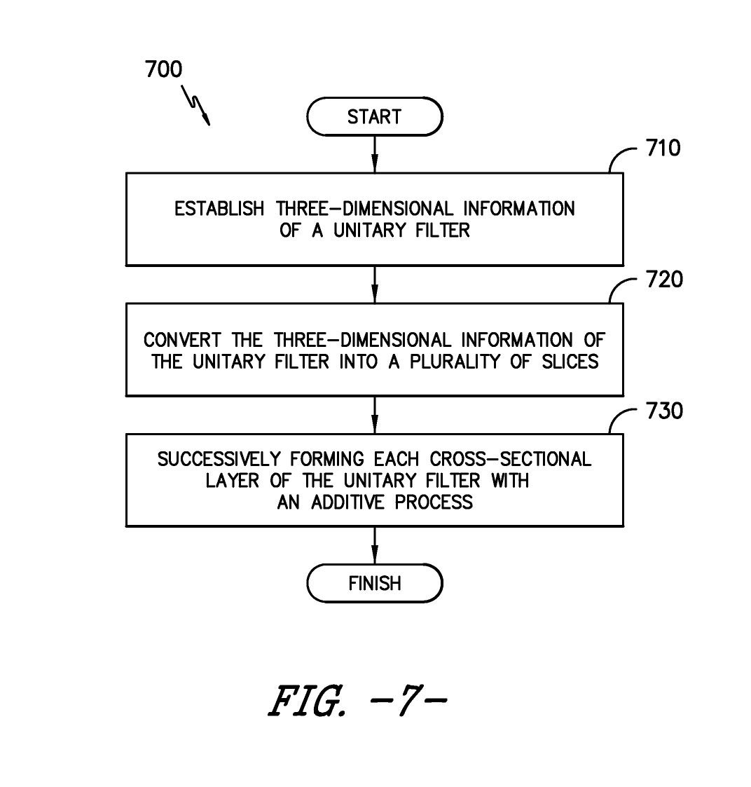

FIG. 3 provides a perspective view of a unitary filter 200 according to an exemplary embodiment of the present subject matter. FIG. 4 provides a side, elevation view of unitary filter 200. FIG. 5 provides a top, plan view of unitary filter 200. FIG. 6 provides a section view of unitary filter 200. As used herein, the term “unitary” may mean that filter 200 is constructed of a single, continuous piece of material. For example, unitary filter 200 may be integrally formed of or with a single continuous piece of plastic, e.g., in the manner described in greater detail below.

Unitary filter 200 may be used in any suitable appliance. For example, unitary filter 200 may be used in dishwasher appliance 100 (FIG. 1) to filter wash fluid urged from wash chamber 106 by recirculation pump 154 or drain pump 156. Thus, while described in the context of dishwasher appliance 100, it should be understood that unitary filter 200 may be used to treat or filter any suitable fluid.

Unitary filter 200 defines a central axis AL, and unitary filter 200 may be generally symmetrical about the central axis AL. Thus, as may be seen in FIG. 3, unitary filter 200 may have a tapered cylindrical shape. It should be understood that the shape of unitary filter 200 shown in FIGS. 3-6 is provided by way of example only and that in alternative exemplary embodiments, unitary filter 200 may have any other suitable shape, e.g., that includes any number of the features discussed below for the exemplary embodiment of unitary filter 200 shown in FIGS. 3-6.

Unitary filter 200 includes a filter medium 210, e.g., that extends along a circumferential direction C about the central axis AL. Filter medium 210 defines pores 230 that permit fluid to flow through filter medium 210. In particular, filter medium 210 has an inner surface 212 and an outer surface 214, and pores 230 extend through filter medium 210 from inner surface 212 of filter medium 210 to outer surface 214 of filter medium 210. Inner surface 212 of filter medium 210 is positioned opposite outer surface 214 of filter medium 210 on filter medium 210. In certain exemplary embodiments, a shape of outer surface 214 of filter medium 210 corresponds to or matches a shape of inner surface 212 of filter medium 210, e.g., when filter medium 210 has a constant or uniform thickness along a radial direction R. Fluid may flow through filter medium 210 from inner surface 212 of filter medium 210 to outer surface 214 of filter medium 210 (or vice versa) through pores 230 in order to filter the fluid with filter medium 210. Inner surface 212 of filter medium 210 defines an interior chamber 216. Filter medium 210 is positioned between interior chamber 216 and outer surface 214 of filter medium 210, e.g., along the radial direction R.

The shape of filter medium 210 may assist with increasing a filter capacity of unitary filter 200. For example, a cross-sectional area of interior chamber 216, e.g., in a plane that is perpendicular to the central axis AL, may change along a length of the central axis AL. In particular, filter medium 210 extends between a first end portion 218 and a second end portion 220 along an axial direction A, e.g., that is parallel to the central axis AL. The cross-sectional area of interior chamber 216, e.g., in the plane that is perpendicular to the central axis AL, may change between first and second end portions 218, 220 of the filter medium 210. As shown in FIG. 6, a middle portion 222 of the filter medium 210 is positioned between the first and second end portions 218, 220 of the filter medium 210, e.g., along the axial direction A. The cross-sectional area of interior chamber 216, e.g., in the plane that is perpendicular to the central axis AL, decreases from the first end portion 218 of filter medium 210 to the middle portion 222 of the filter medium 210. Similarly, the cross-sectional area of interior chamber 216, e.g., in the plane that is perpendicular to the central axis AL, decreases from the second end portion 220 of the filter medium 210 to the middle portion 222 of the filter medium 210. Thus, filter medium 210 may be tapered from first and second end portions 218, 220 of filter medium 210 towards middle portion 222 of filter medium 210.

As may be seen in FIG. 6, the inner surface 212 of filter medium 210 may also be curved, e.g., parabolically or arcuately, between the first and second end portions 218, 220 of the filter medium 210 Inner surface 212 of filter medium 210 may be shaped such that inner surface 212 of filter medium 210 is concave or convex, e.g., between the first and second end portions 218, 220 of the filter medium 210, in various exemplary embodiments. In addition, inner surface 212 of filter medium 210 may be rippled or scalloped, e.g., along the circumferential direction C. Such shaping of inner surface 212 of filter medium 210 may assist with increasing the filter capacity of unitary filter 200. In particular, by curving inner surface 212 of filter medium 210 and/or rippling inner surface 212 of filter medium 210, the total surface area of inner surface 212 of filter medium 210 may be increased relative to a flat and/or linear inner surface 212.

Other features of filter medium 210 may also assist with improving performance of unitary filter 200. For example, filter medium 210 defines a plurality of pores 230. A pore size of each pore of pores 230 may be relatively small, e.g., compared to pore sizes of current filter media. For example, the pore size of each pore of pores 230 may be less than twenty-five thousandths of an inch and greater than three thousandths of an inch. As another example, the pore size of each pore of pores 230 may be less than twenty-five hundredths of an inch and greater than three thousandths of an inch. Such pore sizes may be produced when unitary filter 200 is constructed according to the manner described in greater detail below in the context of FIG. 7.

In addition, filter medium 210 also defines a thickness T, e.g., along the radial direction R that is perpendicular to the axial direction A. The thickness T of filter medium 210 may be any suitable thickness. For example, the thickness T of filter medium 210 may be less than one hundredth of an inch. As another example, the thickness T of filter medium 210 may be less than five hundredths of an inch. As yet another example the thickness T of filter medium 210 may be less than one tenth of an inch. A filtration open area of filter medium 210 may also be greater than forty percent. The filtration open area of filter medium 210 may be greater than fifty percent, sixty percent, etc. in alternative exemplary embodiments. As used herein, the term “filtration open area” corresponds to the sum of all the areas of pores 230 in filter medium 210 through which fluid can pass and is expressed as a percentage of the effective filtration area. The effective filtration area of filter medium 210 corresponds to the total area of filter medium 210 that is exposed to fluid flow and is usable for a filtration process.

Such sizing of filter medium 210 may assist with increasing the filter capacity of unitary filter 200. In particular, by having a relatively thin filter medium 210 and/or relatively high filtration open area, clogging of unitary filter 200 may be reduced. Such thickness and/or filtration open area of filter medium 210 may be produced when unitary filter 200 is constructed according to the manner described in greater detail below in the context of FIG. 7.

FIG. 7 illustrates a method 700 for forming a unitary filter according to an exemplary embodiment of the present subject matter. Method 700 may be used to form any suitable unitary filter. For example, method 700 may be used to form unitary filter 200 (FIG. 3). Thus, method 700 is described in greater detail below in the context of unitary filter 200. Method 700 permits formation of various features of unitary filter 200, as discussed in greater detail below.

Method 700 includes fabricating unitary filter 200, e.g., such that unitary filter 200 is formed of a single continuous piece of plastic or other suitable material. More particularly, method 700 includes manufacturing or forming unitary filter 200 using an additive process, such as Fused Deposition Modeling (FDM), Selective Laser Sintering (SLS), Stereolithography (SLA), Digital Light Processing (DLP) and other known processes. An additive process fabricates plastic components using three-dimensional information, for example a three-dimensional computer model, of the component. The three-dimensional information is converted into a plurality of slices, each slice defining a cross section of the component for a predetermined height of the slice. The component is then “built-up” slice by slice, or layer by layer, until finished.

Accordingly, at step 710, three-dimensional information of unitary filter 200 is determined. As an example, a model or prototype of unitary filter 200 may be scanned to determine the three-dimensional information of unitary filter 200 at step 130. As another example, a model of unitary filter 200 may be constructed using a suitable CAD program to determine the three-dimensional information of unitary filter 200 at step 710. At step 720, the three-dimensional information is converted into a plurality of slices that each define a cross-sectional layer of unitary filter 200. As an example, the three-dimensional information from step 710 may be divided into equal sections or segments, e.g., along the central axis AL of unitary filter 200 or any other suitable axis. Thus, the three-dimensional information from step 710 may be discretized at step 720, e.g., in order to provide planar cross-sectional layers of unitary filter 200.

After step 720, unitary filter 200 is fabricated using the additive process, or more specifically each layer is successively formed at step 730, e.g., by fusing or polymerizing a plastic using laser energy or heat. The layers may have any suitable size. For example, each layer may have a size between about five ten-thousandths of an inch and about one thousandths of an inch. Unitary filter 200 may be fabricated using any suitable additive manufacturing machine as step 730. For example, any suitable laser sintering machine, inkjet printer or laserjet printer may be used at step 730.

Utilizing method 700, unitary filter 200 may have fewer components and/or joints than known filters. Specifically, unitary filter 200 may require fewer components because unitary filter 200 may be a single piece of continuous plastic, e.g., rather than multiple pieces of plastic joined or connected together. Also, the shape and contours of unitary filter 200 described above may be formed using method 700. As a result, a filtering capacity of unitary filter 200 may provide improved relative to other filters. Also, unitary filter 200 may be constructed with relatively thin walls and numerous small pores compared to other filters, e.g., formed with injected molded plastic.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A dishwasher appliance, comprising:
a tub defining a wash chamber;
a sump assembly positioned at a bottom portion of the tub, the sump assembly comprising a pump and a unitary filter, the pump configured for urging wash fluid from the wash chamber of the tub through the unitary filter, the unitary filter defining a central axis, the unitary filter having a filter medium with an inner surface that defines an interior chamber of the filter medium, a cross-sectional area of the interior chamber in a plane that is perpendicular to the central axis changing along a length of the central axis.

2. The dishwasher appliance of claim 1, wherein the filter medium extends between a first end portion and a second end portion along the central axis, a middle portion of the filter medium positioned between the first and second end portions of the filter medium, the cross-sectional area of the interior chamber in the plane that is perpendicular to the central axis decreasing from the first end portion of the filter medium to the middle portion of the filter medium.

3. The dishwasher appliance of claim 2, wherein the cross-sectional area of the interior chamber in the plane that is perpendicular to the central axis decreases from the second end portion of the filter medium to the middle portion of the filter medium.

4. The dishwasher appliance of claim 3, wherein the inner surface of the filter medium is curved between the first and second end portions of the filter medium.

5. The dishwasher appliance of claim 1, wherein the inner surface of the filter medium is rippled.

6. The dishwasher appliance of claim 1, wherein a shape of the outer surface of the filter medium corresponds to a shape of the inner surface of the filter medium.

7. The dishwasher appliance of claim 1, wherein the filter medium defines a plurality of pores, a pore size of each pore of the plurality of pores being less than twenty-five thousandths of an inch and greater than three thousandths of an inch.

8. The dishwasher appliance of claim 1, wherein the filter medium defines a thickness along a direction that is perpendicular to the central axis, the thickness of the filter medium being less than one hundredth of an inch.

9. The dishwasher appliance of claim 1, wherein a filtration open area of the filter medium is greater than forty percent.

10. The dishwasher appliance of claim 1, wherein the filter medium is integrally formed of a single continuous piece of plastic.

11. A method for forming a unitary filter for a dishwasher appliance, comprising:
establishing three-dimensional information of the unitary filter;
converting the three-dimensional information of the unitary filter from said step of establishing into a plurality of slices, each slice of the plurality of slices defining a respective cross-sectional layer of the unitary filter; and
successively forming each cross-sectional layer of the unitary filter with an additive process;
wherein, after said step of successively forming, the unitary filter defines a central axis and has a filter medium with an inner surface that defines an interior chamber of the filter medium, a cross-sectional area of the interior chamber in a plane that is perpendicular to the central axis changing along a length of the central axis after said step of successively forming.

12. The method of claim 11, wherein the filter medium extends between a first end portion and a second end portion along the central axis after said step of successively forming, a middle portion of the filter medium positioned between the first and second end portions of the filter medium after said step of successively forming, the cross-sectional area of the interior chamber in the plane that is perpendicular to the central axis decreasing from the first end portion of the filter medium to the middle portion of the filter medium.

13. The method of claim 12, wherein the cross-sectional area of the interior chamber in the plane that is perpendicular to the central axis decreases from the second end portion of the filter medium to the middle portion of the filter medium after said step of successively forming.

14. The method of claim 13, wherein the inner surface of the filter medium is curved between the first and second end portions of the filter medium after said step of successively forming.

15. The method of claim 11, wherein the inner surface of the filter medium is rippled after said step of successively forming.

16. The method of claim 11, wherein the filter medium defines a plurality of pores after said step of successively forming, a pore size of each pore of the plurality of pores being less than twenty-five thousandths of an inch and greater than three thousandths of an inch.

17. The method of claim 11, wherein the filter medium defines a thickness along a direction that is perpendicular to the central axis after said step of successively forming, the thickness of the filter medium being less than one hundredth of an inch.

18. The method of claim 11, wherein a filtration open area of the filter medium is greater than forty percent after said step of successively forming.

19. The method of claim 11, wherein the additive process comprises at least one of fused deposition modeling, selective laser sintering, stereolithography, and digital light processing.

20. The method of claim 11, wherein the filter medium is integrally formed of a single continuous piece of plastic after said step of successively forming.
